(19) United States
(12) Patent Application Publication
(10) Pub. No.: US 2009/0126465 A1
(43) Pub. Date: May 21, 2009

(54) LEAK DETECTION SYSTEM FOR A DISHWASHER AND ASSOCIATED METHOD

(75) Inventors: Fred Dennis Kedjierski, Kinston, NC (US); Douglas J. Nagel, Kinston, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 11/941,441

(22) Filed: Nov. 16, 2007

(51) Int. Cl. G01M 3/00

(52) U.S. Cl. 73/40.5 R

(57) ABSTRACT

A leak detection system for a dishwasher is provided, such a leak detection system comprises a catch pan having a bottom portion and adapted to collect a leaking fluid therein. The leak detection system further comprises a leak detection device mounted above the bottom portion of the catch pan. The leak detection device includes a body portion with adjacent and spaced apart first and second contacts extending therefrom toward the bottom portion of the catch pan. One of the first and second contacts extends further toward the bottom portion than the other of the first and second contacts, so as to space the other of the first and second contacts from the bottom portion of the catch pan. An associated method is also provided.

### BACKGROUND OF THE INVENTION

1. Field of the Invention

The present disclosure relates to dishwashers and, more particularly, to a leak detection system for a dishwasher and associated method.

2. Description of Related Art

A dishwasher is typically mounted in a cabinet in an under-counter arrangement such that the tub is accessible only through the front door of the unit. Because of the concealed mounting of the dishwasher unit, it may be difficult to determine if the unit is leaking water. In such instances, a leak may not be discovered until significant damage is done to the floor and/or cabinets about the dishwasher unit. As a result, some dishwasher units may include a “catch pan” as a part of the dishwasher assembly, or as an accessory to be used during installation of the dishwasher. However, even such a catch pan may not give advanced warning about a water leak, which may end up causing significant damage if not expediently remedied. In response to such issues, leak detection systems have been developed and implemented with an intent of notifying a user of a leaking dishwasher. However, such systems may have been prone to providing false signals due to, for example, condensation between electrodes, or contact between the electrodes and other metallic parts.

Thus, there exists a need for a leak detection system for a dishwasher that is configured to avoid or minimize false signals of water leakage.

### BRIEF SUMMARY OF THE INVENTION

The above and other needs are met by the present disclosure which, in one embodiment, provides a leak detection system for a dishwasher. More particularly, the leak detection system comprises a catch pan having a bottom portion and adapted to collect a leaking fluid therein. The leak detection system further comprises a leak detection device mounted above the bottom portion of the catch pan. The leak detection device includes a body portion with adjacent and spaced apart first and second contacts extending therefrom toward the bottom portion of the catch pan. One of the first and second contacts extends further toward the bottom portion than the other of the first and second contacts, so as to space the other of the first and second contacts from the bottom portion of the catch pan.

Another advantageous aspect of the present invention comprises a method for detecting a leak in a dishwasher. As described above with respect to the leak detection system embodiment, the leak detection system includes a catch pan adapted to collect a leaking fluid therein and a leak detection device having a body portion with first and second contacts of different configuration relative to the catch pan. The method comprises mounting a leak detection device above a bottom portion of the catch pan, and generating a signal when leaking fluid accumulating in the catch pan contacts both the first and second contacts.

Thus, the leak detection system and method for more effectively detecting a leak in a dishwasher, as described in the embodiments of the present disclosure, provide many advantages that may include, but are not limited to, avoiding or minimizing false signals as possible with other leak detection systems.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates a top plan schematic view of a leak detection system according to one embodiment of the present disclosure;

FIG. 2 illustrates a partial side elevation schematic view of a leak detection system according to one embodiment of the present disclosure;

FIG. 3 illustrates a partial side elevation schematic view of a leak detection system according to another embodiment of the present disclosure;

FIG. 4 illustrates a perspective view of a leak detection device according to the embodiment shown in FIG. 3 of the present disclosure; and

FIG. 5 illustrates an electrical schematic of one possible configuration for a leak detection device according to the present disclosure.

### DETAILED DESCRIPTION OF THE INVENTION

The present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout.

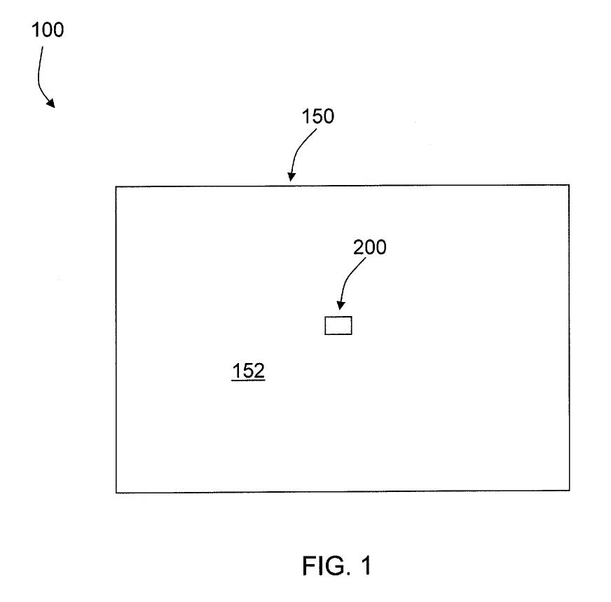

FIG. 1 generally illustrates a leak detection system, generally designated 100, according to one embodiment of the present disclosure. Leak detection system 100 may include a catch pan, generally designated 150, and a leak detection device, generally designated 200. Leak detection system 100 is configured to detect rising levels of a fluid (e.g., water) as the fluid accumulates and collects within a defined space such as, for example, within a catch pan 150. For example, leak detection system 100 may be adapted for use with a dishwasher unit configured to direct leaking fluid to a central collection location such that, when and if the dishwasher unit leaks into the central collection location or “catch pan”, a signal may be generated in response to the leak to notify the user of the leak or, in other embodiments, to disable the operation of the dishwasher unit. Advantageously, leak detection device 200 may be mounted to or relative to catch pan 150 so as to be capable of interacting with the liquid collection portion thereof.

According to some embodiments, leak detection system 100 may include catch pan 150 having a bottom portion 152. Catch pan 150 may be configured in any suitable form, shape, or design for collecting leaking fluid therein from a dishwasher. In some embodiments, catch pan 150 may be a component of the dishwasher or the base of the dishwasher. In other embodiments, catch pan 150 may be provided as a separate accessory placed under and implemented upon installation of the dishwasher. Catch pan 150 may have sidewalls (not shown) to facilitate collection of the leaking fluid in a liquid containing volume. In some instances, catch pan 150 may be formed from a polymeric material, for example, to reduce corrosion or to facilitate the fitting of components within the base of the dishwasher. Leak detection device 200 may be mounted above bottom portion 152 of catch pan 150 and, in some instances, anywhere within the space defined by catch pan 150. In one embodiment, leak detection device 200 may be positioned substantially central within catch pan 150, as generally illustrated in FIG. 1. In some embodiments, leak detection device 200 may be configured such that a mounting bracket is unnecessary, as explained further below. In other embodiments, leak detection device 200 may be attached to a mounting bracket (not shown) configured to be mounted relative to bottom portion 152 of catch pan 150 so as to support leak detection device 200 above bottom portion 152 of catch pan 150. The mounting bracket may be attached to bottom portion 152 of catch pan 150 in any suitable manner, including by use of fasteners such as, for example, screws, adhesives, and rivets. In other instances, leak detection device 200 may be mounted to other components of the dishwasher, wherein such mounting causes leak detection device 200 to extend into catch pan 150 so as to be proximate bottom portion 152.

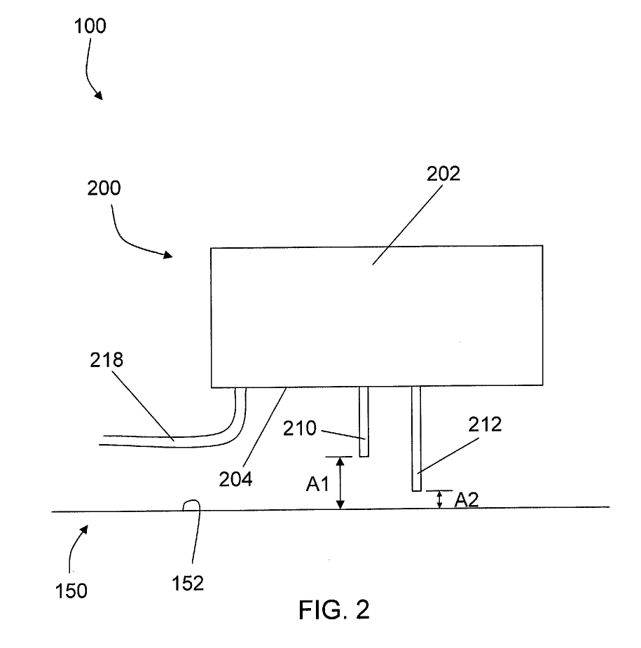

FIG. 2 illustrates a partial side view of leak detection system 100 according to one advantageous embodiment of the present disclosure wherein leak detection device 200 may be mounted proximate to and above bottom portion 152 of catch pan 150 for detecting fluid leaks from the dishwasher that collect therein as described above with respect to FIG. 1. Leak detection device 200 may include both power and ground leads (i.e., 12 VDC) extending thereto from the main circuit board or detection circuit of the dishwasher, and may also include a signal lead extending therefrom for providing a signal to the main circuit board (i.e., controller or main board of the dishwasher) if a leak is detected by leak detection device 200 when a particular accumulation of water in catch pan 150 is sufficient to complete a circuit between the power and ground leads, as further described hereinbelow.

In one embodiment, as shown in FIG. 2, leak detection device 200 may include a body portion 202, a first contact 210 and a second contact 212. In addition, leak detection device may include a plurality of wires 218 for linking leak detection device 200 with a main circuit board or other component of the dishwasher. Body portion 202 may include a bottom side 204. First contact 210 and second contact 212 may be spaced-apart and elongate. Furthermore, leak detection device 200 may be mounted such that first contact 210 and second contact 212 extend from bottom side 204 of body portion 202 toward bottom portion 152 of catch pan 150. When positioned above bottom portion 152 of catch pan 150, first contact 210 and second contact 212 of leak detection device 200 may be oriented perpendicularly with bottom portion 152. In some particular embodiments, first contact 210 and second contact 212 may be comprised of an electrically conductive material and, in some instances, of gold, gold-plated brass, or stainless steel to limit corrosion. Furthermore, first contact 210 and second contact 212 may be configured so as to be exposed to the possible accumulation of water in catch pan 150. Leak detection device 200 may be configured such that second contact 212 (the longer contact) contacts or is suspended above bottom portion 152. Body portion 202 of leak detection device 200 may comprise a printed circuit board or other detection circuit (not shown). First contact 210 and second contact 212 may be in communication with the printed circuit board or detection circuit. The components contained within body portion 202 may be packaged in a suitable manner as known by those of skill in the art. For example, the components of leak detection device 200 may be potted into body portion 202.

With continuing reference to FIG. 2, second contact 212 may extend further toward bottom portion 152 of catch pan 150 than first contact 210. That is, a distance Al between bottom portion 152 of catch pan 150 and first contact 210 is greater than a distance A2 between bottom portion 152 of catch pan 150 and second contact 212. As such, when leaking water accumulates in catch pan 150, the water level reaches second contact 212 before contacting first contact 210. Accordingly, leak detection device 200 may be configured such that first contact 210 and second contact 212 comprise an open circuit having a potential drop therebetween. Thus, the water level in catch pan 150 would first rise to a level sufficient to contact second contact 212 and then continue to rise to contact first contact 210. When water is present between and contacts both first contact 210 and second contact 212, the circuit is completed and a low current passes through the water between first contact 210 and second contact 212 to generate a signal indicating that a leak has occurred, as further explained below.

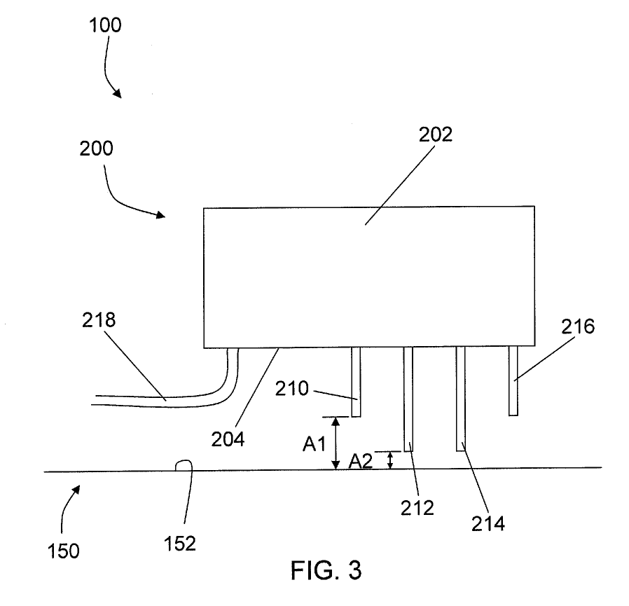

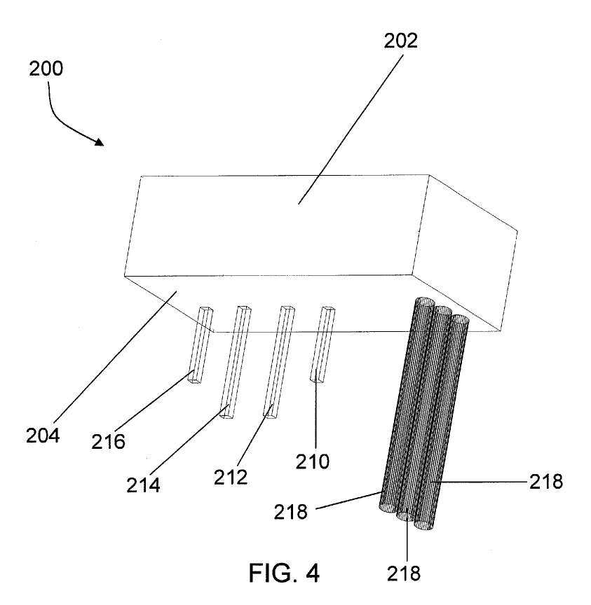

In other embodiments, leak detection device 200 may further include a third contact 214 and a fourth contact 216, as illustrated in FIGS. 3 and 4, wherein these additional contacts may be used as one of the electrically active contacts of the open circuit such that any of the contacts may be used in conjunction with first contact 210 to comprise the open circuit. For example, if first contact 210 and fourth contact 216 comprise the open circuit, then the water level may rise to a level equivalent to distance Al so as to contact both first contact 210 and fourth contact 216 to complete the circuit. In such embodiments, second contact 212 and third contact 214 may be electrically inactive, thereby providing spacing from bottom portion 152 of catch pan 150. Further, by using inactive contacts 212, 214 to create a wall-like structure between active contacts 210, 216, such embodiments may advantageously minimize or prevent false triggers that could result, for example, from a rodent or insect lodging itself between the active contacts 210, 216 and completing the circuit. In other embodiments, first contact 210 and third contact 214 may be the active contacts forming the open circuit. This configuration would be similar to that described above in FIG. 2 with third contact 214 extending further toward bottom portion 152 of catch pan 150 than first contact 210. According to still other embodiments, a three-contact configuration (not shown) may be implemented, wherein the center contact may be inactive. In such a configuration, the center or longer contact may provide a predetermined minimum vertical spacing of the active contacts from catch pan 150 so as to limit false triggers, as otherwise disclosed herein. Such a configuration may also provide the wall-like structure between the active contacts (opposingly positioned about the center contact), for example, to prevent a rodent or insect from becoming lodged between the active contacts, and generating a false signal by completing the circuit between the active contacts.

In use, if water is present between and connects contacts 210 and 212, a low current is passed through the water between contacts 210 and 212. For example, as illustrated in FIG. 2, water may accumulate in bottom portion 152 of catch pan 150 such that the water level rises to a level equivalent to distance A1, thereby contacting second contact 212. If the collected water is present on bottom portion 152 simply due to condensation, then a signal identifying a leak will not be generated because the water is not also contacting first contact 210 positioned at distance A2 from bottom portion 152 of catch pan 150 to complete the circuit. One skilled in the art will also appreciate that relatively wide spacing of the contacts may also minimize the effects of condensation collecting therebetween, since it may be less likely for the condensation to span the gap between electrically active contacts. However, if an actual leak is occurring, the water level will continue to rise to distance A1 and contact first contact 210 in addition to contacting second contact 212, thereby completing the circuit and generating a signal that may, for example, disable the operation of the dishwasher to prevent further leakage. The user may also be notified as to the leak in some manner known and appreciated by those of skill in the art. For example, an indicia such as, a visual indicator, a sound, or any other suitable perceptible action, or combinations thereof, may be generated in response to the leakage signal to notify the user.

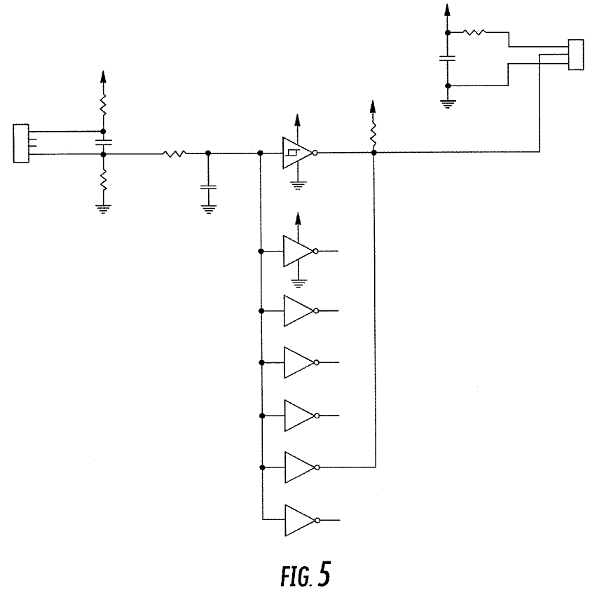

As an example, in one particular embodiment, as will be appreciated by one of skill in the art, leak detection device 200 may be configured to have detection circuit as illustrated in the electrical schematic of FIG. 5. In some instances, a printed circuit board or other detection circuit may be disposed within body portion 202 of leak detection device 200. As known by one of skill in the art, the printed circuit board or other detection circuit may include, for example, a Schmidt trigger gate that is actuated when water contacts both first contact 210 and second contact 212. Furthermore, in some embodiments, a printed circuit board may be configured to include a high impedance network that only permits a low current to pass between first contact 210 and second contact 212 such that, when the circuit is completed by the fluid contacting both first contact 210 and second contact 212, the maximum current flowing therebetween may be configured to be, for example, 1 microamp at 12 VDC isolated. In one instance, the Schmidt trigger gate provides, for example, a high impedance input, while also providing, for instance, a snap action signal that prohibits “half states” or oscillations. To that end, in the event of a full catastrophic failure, where 120 VAC isolation is lost, the current from leak detection device 200 will present a minimal electrocution risk.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A leak detection system for a dishwasher, the system comprising:
a catch pan having a bottom portion and adapted to collect a leaking fluid therein; and
a leak detection device mounted above the bottom portion of the catch pan, the leak detection device having a body portion with adjacent and spaced apart first and second contact elements extending therefrom toward the bottom portion, one of the first and second contact elements extending further toward the bottom portion than the other of the first and second contact elements, so as to space the other of the first and second contact elements from the bottom portion of the catch pan.

2. A leak detection system according to claim 1, wherein the first and second contact elements comprise an open circuit, the open circuit being closed by contact between the leaking fluid and the first and second contact elements.

3. A leak detection system according to claim 1, wherein the first and second contact elements are oriented perpendicularly to the bottom portion of the catch pan.

4. A leak detection system according to claim 1, wherein the first and second contact elements comprise an electrically conductive material.

5. A leak detection system according to claim 4, wherein the first and second contact elements comprise at least one of gold and stainless steel.

6. A leak detection system according to claim 1, wherein the leak detection device further comprises a detection circuit having the first and second contact elements in communication therewith.

7. A leak detection system according to claim 1, wherein the leak detection device further comprises a third contact element extending from the body portion, the third contact element being adjacent and spaced apart from the first and second contacts, and oriented perpendicularly to the bottom portion of the catch pan.

8. A leak detection system according to claim 7, wherein the third contact element extends from the body portion substantially equal to one of the first and second contact elements.

9. A leak detection system according to claim 8, wherein the third contact element and one of the first and second contact elements comprise an open circuit, the open circuit being closed by contact between the leaking fluid, the third contact element, and the one of the first and second contact elements.

10. A method for detecting a leak in a dishwasher, the method comprising:
mounting a leak detection device above a bottom portion of a catch pan adapted to collect a leaking fluid therein, the leak detection device having a body portion with adjacent and spaced apart first and second contact elements extending therefrom toward the bottom portion, one of the first and second contact elements extending further toward the bottom portion than the other of the first and second contact elements, so as to space the other of the first and second contact elements from the bottom portion of the catch pan; and
generating a signal when leaking fluid accumulating in the catch pan contacts both the first and second contact elements.

11. A method according to claim 10, further comprising actuating an indicia in response to the signal so as to provide notification that the leaking fluid is accumulating in the catch pan.

12. A method according to claim 10, wherein generating a signal further comprises establishing a potential drop across the first and second contact elements, such that the leaking fluid contacting the first and second contact element causes a current flow therebetween, the current flow thereby completing a detection circuit.
